(19) United States
(12) Patent Application Publication
(10) Pub. No.: US 2005/0053436 A1
(43) Pub. Date: Mar. 10, 2005

(54) Method and apparatus for carpet repair

(76) Inventor: Virgil G. Atkins, Butte, MT (US)

Correspondence Address: LITMAN LAW OFFICES, LTD., P.O. BOX 15035 CRYSTAL CITY STATION, ARLINGTON, VA, 22215, US

(21) Appl. No.: 10/658,368

(22) Filed: Sep. 10, 2003

(51) Int. Cl. B23B 51/04; B27B 5/12; B23B 41/02

(52) U.S. Cl. 408/204

(57) ABSTRACT

The carpet cutting tool is a hollow cylinder with an open end defining a sharp circumferential edge for cutting circular sections of carpet. An arbor shaft extends outward from the closed end of the cylinder, and is adapted to connect to a drive mechanism. The drive mechanism provides rotary motion to the cylinder and the rotating cutting edge is used to cut out a damaged section of carpet. Once the damaged section is removed, a piece of semi-rigid material covered by mesh material is inserted into the opening to form a backing for a replacement piece of carpet. The replacement piece of carpet is cut out using the carpet cutting tool, and is inserted into the opening. Common adhesive or bonding agent is used to secure the replacement segment to the backing.

### BACKGROUND OF THE INVENTION

1. Field of the Invention

The present invention relates to a method and apparatus for carpet repair, and particularly to a carpet cutting tool and method for removing a section of damaged carpet and replacing the damaged section with a new section of carpet.

2. Description of the Related Art

Carpet stains and burns in carpets are a frequent problem for homeowners and business owners alike. In many cases, carpet cleaners and detergents are unable to remove stains or restore damaged areas to their original look and feel. In such case, replacing the damaged piece of carpet with a new section of carpet may be the simplest, most economical solution. However, ordinary tools are usually not suitable for this purpose and risk causing further damage to the carpet. Specialized tools and methods have therefore been developed to address this problem.

U.S. Pat. No. 3,171,200, issued Mar. 2, 1965 to Poppenga, describes a tool for cutting sections of damaged carpet. The tool includes a body having a central opening and an outwardly disposed flange. The flange holds one or more of a plurality of cutter members, while the body holds a plunger rod. A blow to the plunger head is transmitted to the cutting members, which cut through the carpet without cutting the underlying pad or floor surface. Once the damaged section of carpeting is removed, the tool is used to remove a replacement plug section of carpeting from a new piece of carpet. The tool is then used to insert the new section of carpeting into the opening, in such a way that it matches the pattern of the carpet being repaired.

U.S. Pat. No. 3,558,386, issued Jan. 26, 1971 to Ronning, describes a method for repairing damaged carpeting. The method involves cutting and removing the damaged section of carpet, cutting an undamaged section corresponding in size and pattern to the damaged section, lifting the carpeting around the opening from which the damaged section was removed, inserting an adhesive sheet into the opening and spreading it underneath the carpeting that surrounds the opening, lowering the lifted carpet portion and then transposing the section of undamaged carpeting into the opening and pressing it into contact with the adhesive sheet.

U.S. Pat. No. 3,765,282, issued on Oct. 16, 1973 to Crain, Jr., describes a method and apparatus for repairing carpets and similar materials. The damaged section of carpet is anchored in place by the apparatus, while a cutter on the apparatus is rotated around the periphery of the anchored damaged segment. As the damaged section is being cut, it is simultaneously lifted through the carpet along the longitudinal axis of the apparatus.

U.S. Pat. No. 3,786,564, issued Jan. 22, 1974 to Acheson, describes a tool for cutting circular plugs of carpeting through rotary cutting action. The tool includes a housing, a drive rod and a cutter blade assembly. The cutter assembly is mounted on the end of the drive rod, which extends longitudinally through the housing. To cut out a section of carpet, the open end of the tool is placed on the carpet and the drive rod is rotated about its axis, thus bringing the knife-edge into cutting engagement with the carpet. Carpet gripping pins insure that the tool is held in place and that the housing is held against rotation during operation.

U.S. Pat. No. 4,057,898, issued Nov. 15, 1977 to Piosky, describes a repair template for carpets or the like. The template is used to cut out a fixed-size section of damaged carpet, which is replaced with an undamaged piece of carpet having the same size and shape as the piece removed. The template has a circular body and three circumferentially spaced, arcuate knife-guiding grooves located about its periphery. Blades extend down from the grooves and are used to cut out the damaged section of carpet and replace it with a new, identically shaped piece of carpet.

U.S. Pat. No. 4,058,423, issued Nov. 15, 1977 to Bascom et al., describes a carpet repair disk and tool. The manually operated tool cuts a circular plug in a carpet to remove a damaged area. The tool has two cutting blades, which are equally spaced circumferentially on the lower periphery of the tool. Circumferential grooves on a centering pin grip the carpet plug as the cut is being made. After the cut is made, a carpet repair disk is positioned beneath the opening in the carpet. The disk is larger in diameter than the opening and adheres to the backside of the carpet around the opening. A replacement patch can then be placed over the adhesive disk, thus filling the opening.

U.S. Pat. No. 4,875,249, issued Oct. 24, 1989 to Collier, describes a carpet repair steam system for repairing bent carpet fibers. The device includes a steam generator and an application tool having a head with an opening which directs steam downward towards the carpet fibers. The steam is applied at a pressure and temperature which causes the fibers to relax. A fiber lifter on the head is then used to lift the fibers to an upstanding position.

U.S. Pat. No. 4,911,773, issued Mar. 27, 1990 to Leighton, describes a method for repairing damaged carpet. The method calls for removing individual carpet fibers from positions surrounding the damaged section. The fibers are then specially treated and bonded back into the damaged area in a manner that matches the color and pattern of the carpet.

U.S. Patent Publication No. 2001/0054236, published Dec. 27, 2001, describes a cushion back carpet cutting tool. The tool creates a clean, straight cut through the carpeting, resulting in a smooth, unnoticeable seam where two pieces of carpet can be joined. The tool has a leading edge that opens the adjacent rows of tufts in the carpeting and has three blades for cutting the carpeting. The blades can also be adjusted to extend downward to accommodate different thickness of carpeting.

None of the above inventions and patents, taken either singly or in combination, is seen to describe the instant invention as claimed. Thus a method and apparatus for carpet repair solving the aforementioned problems is desired.

### SUMMARY OF THE INVENTION

The carpet cutting tool of the present invention is a hollow, metal cylinder with a circular blade at one end and an arbor attachable at the opposite end. The arbor attaches to a drive mechanism, such as a drill, which causes the cylinder to rotate. The cutting tool is used to cut a circular section of carpet, in order to remove a damaged or stained area of carpet. Care is taken to avoid cutting the mat or pad underneath the carpet.

Once the damaged section of carpet is removed, the carpet cutting tool is used to cut a section of replacement carpet that matches the damaged section of carpet. In addition, a piece of semi-rigid material, such as cardboard, and a piece of mesh material are cut out, each having a diameter slightly greater than the opening. These materials are subsequently inserted through the opening and centered thereunder in such manner that the mesh material covers the semi-rigid material. An adhesive is used to attach the semi-rigid material with mesh covering to the underside of the carpet, thus forming a backing for the replacement piece of carpet. An adhesive is applied to the underside of the replacement piece of carpet, which is then inserted into the opening and attached to the backing. In this way, damaged sections of carpet are replaced with undamaged sections, which blend seamlessly into the surrounding carpet.

Accordingly, it is a principal object of the invention to provide a carpet-cutting tool for removing damaged sections of carpet and the like.

It is another object of the invention to provide a method for removing damaged sections of carpet and replacing the damaged sections with matching sections of undamaged carpet.

It is a further object of the invention to provide a more economical method of repairing damaged carpet Still another object of the invention is to provide a quick and easy way to repair damaged carpet.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is an environmental, perspective view showing the carpet cutting tool and how it connects to a drill chuck.

FIG. 1B is a cross-sectional view of the carpet cutting tool according to the present invention.

FIG. 2 is an environmental, perspective view showing the carpet cutting tool in use, cutting out a circular section of carpet.

FIG. 3 is an environmental, exploded view showing the cardboard backing, mesh material and replacement section of carpet, in the order they are inserted into the opening.

FIG. 4 is a flow diagram showing the steps in a method of repairing a damaged section of carpet according to the present invention.

Similar reference characters denote corresponding features consistently throughout the attached drawings.

### DETAILED DESCRIPTION OF THE PREFERRED EMBODIMENTS

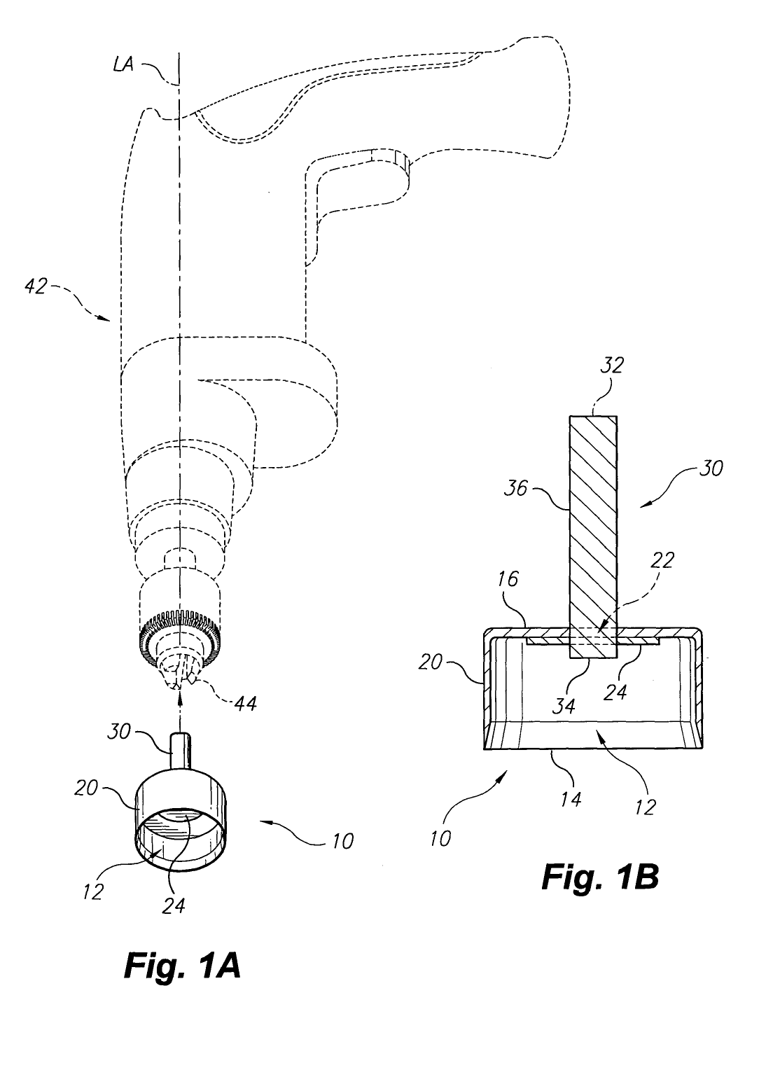

The present invention is a carpet cutting tool, designated generally as 10 in the drawings, and a method for repairing carpet. The carpet-cutting tool 10 is designed to cut out damaged or stained sections of carpet 60. Referring first to FIGS. 1A and 1B, the carpet cutting tool 10 is a hollow cylinder 20 with an open end 12 and a closed end 16. The open end 12 is defined by a circumferential cutting edge 14, which is sharp and smooth, while the closed end 16 has an aperture 22 defined therein through which an arbor shaft 30 is inserted. A fastener 24 secures the cylinder 20 to the arbor shaft 30. Alternatively, the arbor shaft 30 may be bonded or welded to the outer surface of the closed end 16 of the cylinder 20. It will be seen that the cutting tool is similar to a conventional hole saw, except that the cutting edge 14 is not serrated, but smooth and uniform.

As shown in FIG. 1B, the arbor shaft 30 has a first end 32 and a second end 34 with an elongated body 36 extending between the two ends. One end of the arbor shaft 30 is secured to the closed end 16 of the cylinder 20 as described above, while the opposite end 16 extends away from the cylinder 20 and is adapted to be grasped by the chuck of a drive mechanism, preferably a power drill, such as an electric or pneumatic drill 42.

The drive mechanism 42 provides rotary motion to the arbor shaft 30 perpendicular to the longitudinal axis LA of the driving mechanism, which in turn rotates the cylinder 20. A chuck 44 on the drive mechanism secures the arbor shaft 30 in place while the drive mechanism 42 supplies rotary motion.

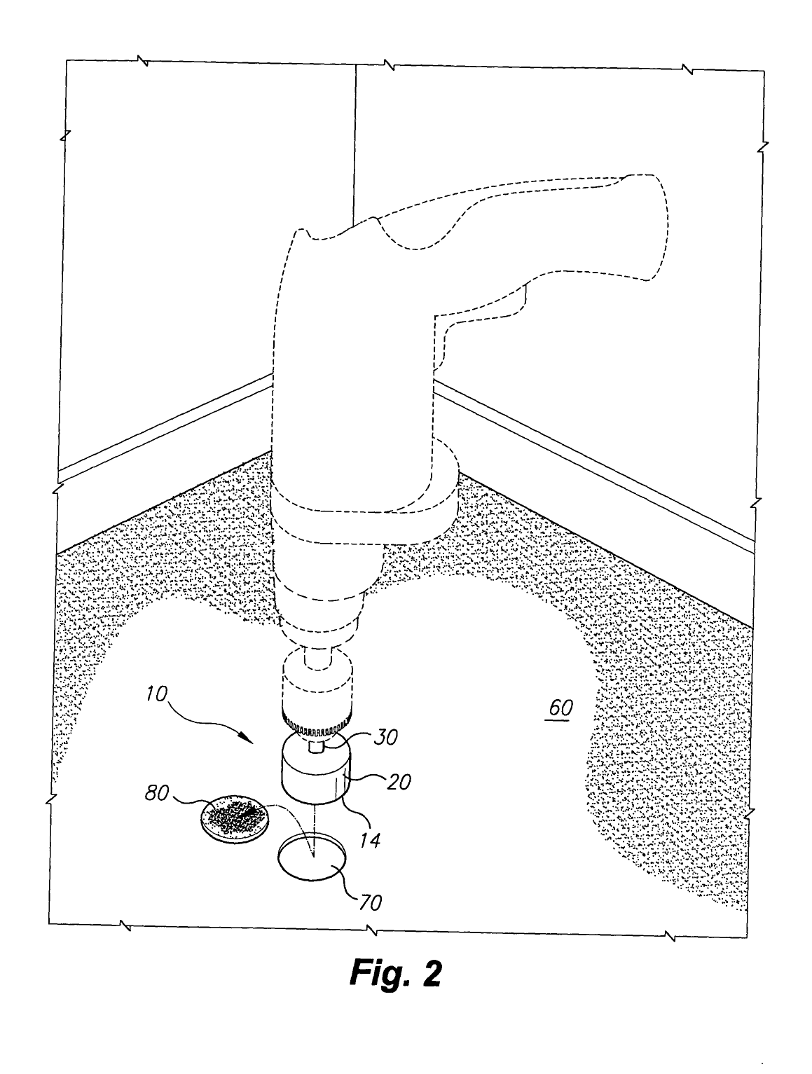

Once the carpet cutting tool 10 is connected to the drive mechanism 42, it can be used to cut out circular sections of damaged or stained carpet, as shown in FIG. 2. The circular cutting edge 14 is placed over the damaged area of carpet 60 and the drive mechanism 42 is activated. The rotary motion of the cutting edge 14 cuts a circular section of damaged carpet 80 corresponding in size to the diameter of the cylinder 20. Different sized cutting tools with varying diameters may be used for cutting different sized segments of damaged carpet.

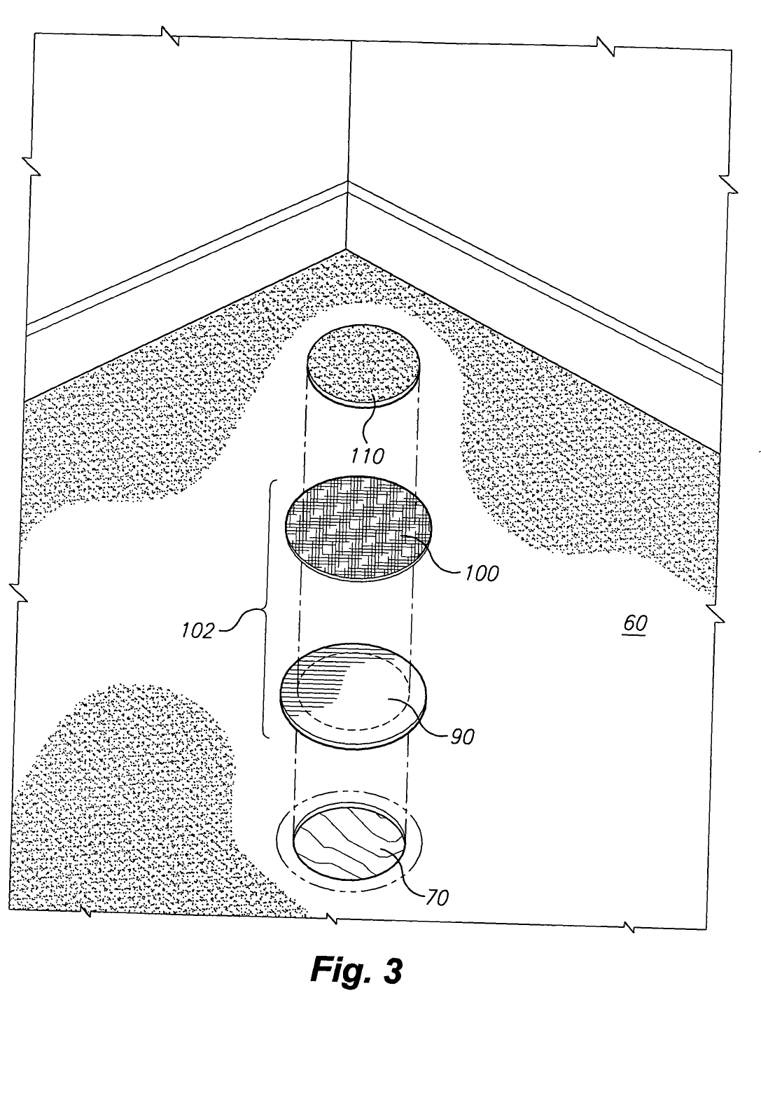

The carpet cutting tool 10 is designed to repair damaged sections of carpet 60, as shown in FIG. 3. First, the carpet cutting tool 10, attached to a drive mechanism (e.g. a handheld drill), is used to cut out the damaged section 80 of carpet 60, forming an opening 70 in the carpet 60. When cutting the damaged section 80, care should be taken not to cut the mat, pad, or flooring beneath the carpet 60. Next, a piece of semi-rigid material 90, such as cardboard, is cut out, having a diameter approximately three inches larger than the opening 70 in the carpet 60, so that at least one and one-half inches of the cardboard 90 will extend radially under the carpet one all sides of the opening. A piece of mesh material 100 matching the size of the semi-rigid material 90 is subsequently cut out for purposes of covering the semi-rigid material 90. The mesh material 100 may be nylon, metal wire, fiberglass, plastic, fiber matting or the like. Together, the semi-rigid material and mesh material form a backing 102 for the replacement piece of carpet 110.

Next, the semi-rigid material 90 is inserted into the opening 70 in the carpet 60 and centered underneath. The material 90 may have to be bent in order to fit through the opening 70. The mesh material 100 is placed through the opening and over the semi-rigid material 90, forming a backing 102 for the replacement section of carpet 110. An adhesive is then applied between the semi-rigid material 90 and the carpet around the opening 70 in order to form the backing 102 and to attach the backing 102 to the underside of the carpet 60.

A replacement section of matching carpet 110 is then cut out from a second undamaged carpet using the carpet cutting tool 10. Adhesive is applied to the underside of the replacement section of carpet 110 and the replacement is inserted into the opening 70, over the backing. The replacement section 110 should be inserted in such manner that any patterns are carefully aligned with the surrounding carpet. A flat weight is then placed over the repaired area, which is allowed to dry.

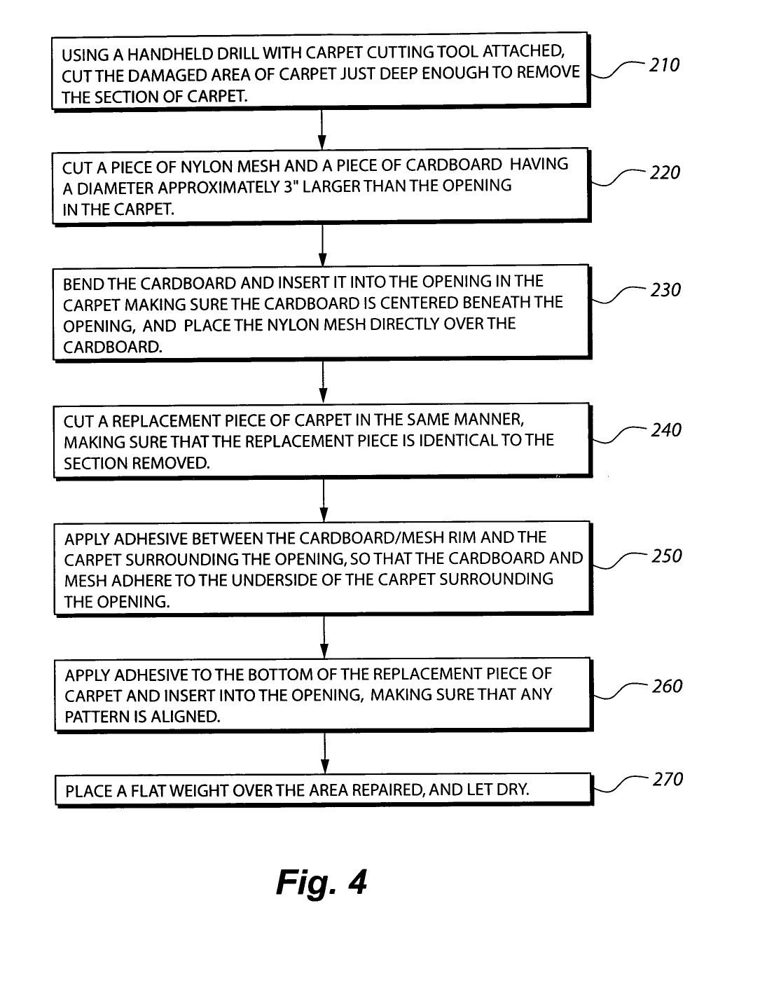

Referring to FIG. 4, a method of replacing a damaged section of a carpet according to the present invention comprises the steps of: using a handheld drill with a carpet cutting tool attached to cut the damaged section of the carpet just deep enough to remove the damaged section of carpet in order to define an opening in the carpet in step 210; cutting a piece of nylon mesh and cutting a piece of cardboard having a diameter approximately three inches larger than the opening in the carpet in step 220; bending the cardboard and inserting the cardboard into the opening in the carpet, centering the cardboard beneath the opening, and inserting the mesh through the opening and placing the nylon mesh directly over the cardboard in step 230; cutting a replacement piece of carpet using the carpet cutting tool in step 240; applying adhesive between the cardboard and the carpet around the opening in the carpet so that the cardboard and the mesh adhere to each other and to the underside of the carpet surrounding the opening in step 250; applying adhesive to a bottom side of the replacement piece of carpet, and inserting the replacement piece into the opening in the carpet, with any pattern aligned in step 260; and placing a flat weight over the replacement piece of carpet and allowing the adhesive to dry in step 270.

It is to be understood that the present invention is not limited to the embodiments described above, but encompasses any and all embodiments within the scope of the following claims.

1. A carpet cutting tool for cutting circular segments out of a carpet, comprising:
a hollow cylinder having an open end and a closed end, the open end having a circumference and a sharp, uniform, smooth cutting edge defined about the circumference of the open end of the cylinder; and
means for attaching the closed end to a power drill;
whereby, the cutting edge is adapted for cutting circular segments of damaged carpeting from the carpet when rotated by the power drill.

2. The carpet cutting tool according to claim 1, wherein said means for attaching comprises a shaft irremovably fixed to the closed end of the cylinder, the shaft being adapted for being gripped by a chuck of the power drill.

3. The carpet cutting tool according to claim 1, wherein:
the closed end of the cylinder has an aperture defined therein; and
said means for attaching comprises an arbor having an arbor shaft removably inserted through the aperture in the closed end, and a fastener attached to the arbor shaft for retaining the cylinder on the arbor shaft.

4. A method of repairing a damaged section of a carpet using the carpet cutting tool of claim 1, comprising the steps of:
(a) cutting and removing a damaged section from the carpet using the carpet cutting tool in order to define an opening in the carpet;
(b) cutting a replacement piece of carpet from an undamaged roll of carpet using the carpet cutting tool;
(c) cutting a piece of mesh material and a piece of semi-rigid material, both the piece of the mesh material and the piece of the semi-rigid material having a diameter about three inches larger than the opening in the carpet;
(d) bending the semi-rigid material and inserting the semi-rigid material through the opening in the carpet in order to lie centered under the opening;
(e) placing the mesh material through the opening and over the semi-rigid material, thus forming a backing for the replacement piece of carpet;
(f) applying an adhesive between the backing and the carpet, so that the backing adheres to the underside of the carpet surrounding the opening;
(g) applying adhesive to the bottom of the replacement piece of carpet and inserting the replacement piece into the opening;
(h) placing a flat weight over the area repaired; and
(i) allowing the adhesive to dry.

5. The method of claim 4, wherein the semi-rigid material is cardboard.

6. The method of claim 4, wherein the mesh material is nylon.

7. The method of claim 4, wherein the mesh material is metal wire.

8. The method of claim 4, wherein the mesh material is fiberglass.

9. The method of claim 4, wherein the mesh material is plastic.

10. The method of claim 4, wherein the mesh material is a fiber matting.
